(19) United States
(12) Patent Application Publication
(10) Pub. No.: US 2021/0340957 A1
(43) Pub. Date: Nov. 4, 2021

(54) CONTROL OF A WIND ENERGY INSTALLATION

(71) Applicant: Siemens Gamesa Renewable Energy Service GmbH, Hamburg (DE)

(72) Inventor: Jens Geisler, Rendsburg (DE)

(21) Appl. No.: 17/288,050

(22) PCT Filed: Oct. 10, 2019
(86) PCT No.: PCT/EP2019/077508

§ 371 Date: Apr. 23, 2021

(30) Foreign Application Priority Data
Oct. 25, 2018 (DE) 10 2018 008 391.9

(51) Int. Cl. F03D 7/04

(52) U.S. Cl. CPC F03D 7/046; F05B 2270/709; F05B 2260/821

(57) ABSTRACT

A method for controlling a wind energy installation having a rotor which is rotatable about a rotor axis and which has at least one rotor blade and a generator coupled thereto. The method includes detecting a value of a forefield parameter, in particular a forefield wind parameter, which is present at a first point in time and in a first region which first region is at a first distance from the wind energy installation, in particular from the rotor blade, in particular detecting a sequence of values of the forefield parameter up to the first point in time with the aid of at least one sensor, and controlling the generator and/or at least one actuator of the wind energy installation on the basis of this detected forefield parameter value, in particular this detected forefield parameter value sequence, and a machine-learned relationship of a predicted near field parameter, in particular a predicted near field wind parameter, at the wind energy installation and/or of an operating parameter of the wind energy installation predicted for a later, second point in time and/or of a control variable of the actuator and/or of the generator to the forefield parameter or the forefield parameter sequences.

### CROSS-REFERENCE TO RELATED APPLICATIONS

This application is a national phase application under 35 U.S.C. § 371 of International Patent Application No. PCT/EP2019/077508, filed Oct. 10, 2019 (pending), which claims the benefit of priority to German Patent Application No. DE 10 2018 008 391.9, filed Oct. 25, 2018, the disclosures of which are incorporated by reference herein in their entirety.

### TECHNICAL FIELD

The present invention relates to a method and a system for controlling a wind energy installation, as well as a computer program product for carrying out the method.

### BACKGROUND

Wind energy installations with rotors and generators coupled to the rotors can be adapted to changing environmental conditions, in particular varying wind speeds, by controlling the generator, as well as various actuators which, for example, rotate rotor blades about their longitudinal axes or which rotate nacelles about a yaw axis, the nacelles supporting the rotor.

### SUMMARY

It is an object of the present invention to improve the operation, in particular the performance, of wind energy installations.

This object is solved by a method as disclosed herein, and by a system and a computer program product for carrying out one of the methods described herein.

According to an embodiment of the present invention, a wind energy installation comprises a rotor which is rotatable, or rotatably supported, about a rotor axis and which has one or more rotor blades, in one embodiment at least two and/or at most five rotor blades, and a generator which is coupled to the rotor, in one embodiment coupled to the rotor via a transmission.

In one embodiment, the rotor is (rotatably) supported on a nacelle, in particular in a nacelle, which in turn, in a further development, is supported on a tower, in particular rotatably, in particular on top of a tower.

In one embodiment, the rotor axis includes an angle with the vertical or with the direction of gravity that is at least 60 degrees and/or at most 120 degrees, and in a further development it is at least substantially horizontal.

In one embodiment, the rotor or the nacelle is rotatable about a yaw axis, in particular supported on the tower, wherein, in one embodiment, the yaw axis includes an angle with the rotor axis which is at least 60 degrees and/or at most 120 degrees, and in a further development it is at least substantially vertical.

The present invention can be used to particular advantage for such wind energy installations due to their environmental conditions and operating conditions.

According to one embodiment of the present invention, a method of controlling the wind energy installation comprises the step of: detecting a value of a one-dimensional or multidimensional forefield parameter, in particular a one-dimensional or multidimensional forefield wind parameter, which is present or which is prevailing at a first point in time and in a first region which first region, in particular in the direction of the rotor axis, is at a first distance greater than zero, in particular at a first minimum or mean distance greater than zero, from the wind energy installation, in particular from the rotor blade or blades, and in particular which (in the direction of the rotor axis) is arranged upstream of, or in front of, the rotor blade or blades, with the aid of one or more sensors, in one embodiment detecting a sequence of values of the forefield parameter up to the first point in time with the aid of the sensor or sensors.

According to an embodiment of the present invention, the method comprises the step of: controlling the generator and/or one or more actuators of the wind energy installation on the basis of this detected forefield parameter value, in particular this detected sequence of forefield parameter values, and a machine-learned relationship.

According to an embodiment of the present invention, this machine-learned relationship assigns a predicted one-dimensional or multidimensional near field parameter (value), in particular a predicted one-dimensional or multidimensional near field wind parameter (value), at the wind energy installation, in particular for a later, second point in time, to each forefield parameter or to each of the values of the forefield parameter or to each of the forefield parameter (value) sequences.

In other words, a correlation between the forefield parameter or forefield parameter sequences, which is or which are present in the first region at, or up to, the first point in time, which first region is spaced apart from the wind energy installation by the first distance and which, in particular, is located in front of the rotor blade or blades, or which forefield parameter or forefield parameter sequences is or are detected by means of the sensor or sensors, and the near field parameter, which is expected to come into existence or to result at the wind energy installation at the, or a later, second, point in time, is learned by machine learning.

By means of this, the near field parameter can, in an embodiment, in particular due to the difficulty of modeling this relationship in a mathematical or theoretical manner, be predicted in a particularly advantageous manner, in particular quickly or more quickly, reliably or more reliably and/or precisely or more precisely, and thus the actuator or actuators and/or the generator can be controlled advantageously in a predictive manner, which can be particularly advantageous, in particular due to the inertias which are inherent or which occur during the course of this control, in particular inertias of a mechanical, hydraulic or electrical nature and/or inertias due to signal technology and/or computing technology, in particular dead times or the like.

In addition or as an alternative, according to an embodiment of the present invention, the machine-learned relationship assigns, to the value or to each of the values of the forefield parameter(s) or forefield parameter (value) sequences, a one-dimensional or multidimensional operating parameter (value) of the wind energy installation which is predicted for a later, second point in time.

In other words, a correlation between the forefield parameter or forefield parameter sequences, which is or which are present in the first region at, or up to, the first point in time, which first region is spaced apart from the wind energy installation by the first distance, or which forefield parameter or forefield parameter sequences is or are detected by means of the sensor or sensors, and the operating parameter which is expected to come into existence or to result in the wind energy installation at the later, second point in time, is learned by machine learning.

By means of this, the operating parameter can, in an embodiment, in particular due to the difficulty of modeling this relationship in a mathematical or theoretical manner, be predicted in a particularly advantageous manner, in particular quickly or more quickly, reliably or more reliably and/or precisely or more precisely, and thus the actuator or actuators and/or the generator can be controlled advantageously in a predictive manner, which can be particularly advantageous, in particular due to the inertias which are inherent or which occur during the course of this control, in particular inertias of a mechanical, hydraulic or electrical nature and/or inertias due to signal technology and/or computing technology, in particular dead times or the like.

In one embodiment, the method comprises the steps of:
predicting the near field parameter (value) and/or the operating parameter (value) on the basis of the detected forefield parameter value or the detected sequence of forefield parameter values and the relationship learned by machine learning;
determining a one-dimensional or a multidimensional control variable of the actuator or actuators and/or of the generator on the basis of this predicted near field parameter and/or the operating parameter, in one embodiment with the aid of a controller; and
controlling the actuator or actuators and/or the generator on the basis of this control variable which has been determined.

In other words, in one embodiment, in a multi-stage manner, the near field parameter or operating parameter is first predicted for the second point in time on the basis of the machine-learned relationship, and then the actuator or actuators and/or the generator is or are controlled (in a predictive manner), in particular with the aid of a controller, which may be a conventional one.

By means of this, in one embodiment, conventional controllers which operate on the basis of the near field parameter or the operating parameter can be used and/or the safety of the operation of the wind energy installation can be increased.

In a similar way, the control scheme can also be integrated into the machine-learned relationship or can (also) be learned by machine learning. By means of this, in one embodiment, the control of the actuator or actuators and/or of the generator can be (further) improved. In the interest of a more compact representation, a control/controlling of the feed-back type or a control/controlling taking into account actual variables which are fed back is also referred to, in a generalizing manner, as control/controlling.

In particular, according to one embodiment of the present invention, the machine-learned relationship assigns, to the value or to each of the values of the forefield parameter(s) or forefield parameter (value) sequences, a one-dimensional or multidimensional control variable of the actuator or actuators and/or for the actuator or actuators and/or of the generator or for the generator.

In other words, a correlation between the forefield parameter or forefield parameter sequences, which is or which are present in the first region at, or up to, the first point in time, which first region is spaced apart from the wind energy installation by the first distance, or which forefield parameter or forefield parameter sequences is or are detected by means of the sensor or sensors, and the control variable on the basis of which the actuator or actuators and/or the generator is/are controlled, is learned by machine learning.

By means of this, the control variable can, in an embodiment, in particular due to the difficulty of modeling this relationship in a mathematical or theoretical manner, be predicted in a particularly advantageous manner, in particular quickly or more quickly, reliably or more reliably and/or precisely or more precisely, and thus the actuator or actuators and/or the generator can be controlled advantageously in a predictive manner, which can be particularly advantageous, in particular due to the inertias which are inherent or which occur during the course of this control, in particular inertias of a mechanical, hydraulic or electrical nature and/or inertias due to signal technology and/or computing technology, in particular dead times or the like.

In one embodiment, the sensor or one or more of the sensors each measures/measure linearly or along a “line-of-sight”, as it is referred to, and/or in a contactless manner, in particular optically, acoustically and/or electromagnetically; in a further embodiment, the sensor or one or more of the sensors is/are each a LIDAR sensor, a SODAR sensor, a RADAR sensor or the like.

By means of this, on the one hand, the forefield parameter (value) or the forefield parameter (value) sequence can, in one embodiment, be detected in a particularly advantageous manner, in particular quickly or more quickly, reliably or more reliably and/or precisely or more precisely. On the other hand, the present invention can be used in a particularly advantageous manner in connection with such sensors or measurements, in particular due to the limitation to a wind speed component along the line-of-sight.

In addition or as an alternative, in one embodiment, the sensor or one or more of the sensors is/are each arranged on the wind energy installation, in particular on the rotor, on the nacelle or on the tower.

In one embodiment, as a result of a nacelle-side arrangement, a respective detected forefield can advantageously be moved or rotated along with the rotor, in one embodiment, as a result of a rotor-side arrangement, interference of a field-of-view from rotor blades can advantageously be avoided, and in one embodiment, as a result of a tower-side arrangement, the sensor or sensors can be connected in an advantageous manner.

In one embodiment, the forefield wind parameter depends on a wind speed, in particular a wind direction and/or a wind force, at one or more locations of the first region, and it may in particular correspond to, or indicate, the same. In addition or as an alternative, the near field wind parameter depends on a wind speed, in particular a wind direction and/or a wind force, at one or more locations on the wind energy installation, in particular on the rotor, in one embodiment on one or more rotor blades, and it may in particular correspond to, or indicate, the same.

Since the wind field in the forefield at (or up to) the first point in time determines the wind field at the rotor at the second point in time to a large extent, and since this in turn determines operating parameters and the control of the wind energy installation to a large extent, in particular of the actuator or actuators and/or of the generator, in one embodiment the wind energy installation can be controlled in a particularly advantageous manner by taking into account wind speeds in the forefield.

In one embodiment, the operating parameter depends on a speed, an acceleration and/or a load of the rotor, in particular of one or more rotor blades, and/or of the nacelle, and/or on a power, in particular a rotational speed and/or a torque of the generator. The load of the nacelle may in particular comprise a thrust force acting thereon and/or a pitch moment and/or a yaw moment acting thereon, and in particular the load of the nacelle may be a thrust force acting thereon and/or a pitch moment and/or a yaw moment acting thereon; the load of the rotor may in particular comprise a torque acting thereon and/or forces and/or moments in the rotor blade or blades, or deformations resulting therefrom, and in particular the load of the rotor may be a torque acting thereon and/or forces and/or moments in the rotor blade or blades, or deformations resulting therefrom.

Since the wind field in the forefield at (or up to) the first point in time determines these operating parameters at the second point in time to a large extent, they can, as a result, be predicted in a particularly advantageous manner and the wind energy installation can, as a result, be controlled in a particularly advantageous manner in one embodiment.

In one embodiment, the actuator or one or more of the actuators adjust/adjusts the rotor blade or one or more of the rotor blades about its/their longitudinal axis or blade axis or is/are set up for this purpose or is/are used for this purpose. In other words, in one embodiment, the actuator or the actuators adjust/adjusts the pitch angle, as it is referred to, in one embodiment in a collective manner, and in another embodiment in a manner which is blade-specific (to a single blade), or are set up for this purpose or are used for this purpose.

In addition or as an alternative, the actuator or one or more of the actuators adjust/adjusts the rotor, in particular the nacelle, about a or the yaw axis or is/are set up for this purpose or is/are used for this purpose. In other words, in one embodiment, the actuator or actuators adjust/adjusts the azimuth, as it is referred to.

A pitch angle adjustment and an azimuth adjustment of a blade which is of a collective type, or of a type which is blade-specific (to a single blade), in addition to generator control, have been found to be particularly advantageous for use with the present invention.

In one embodiment, the relationship is learned by machine learning with the aid of the wind energy installation, which wind energy installation, or its actuator or actuators and/or its generator is/are subsequently controlled on the basis of this relationship.

By means of this, in an advantageous manner, the relationship can be optimized for the conditions prevailing at the wind energy installation that is being controlled, in a manner which is specific to the wind energy installation.

In addition or as an alternative, in one embodiment, the relationship is learned by machine learning with the aid of at least one further wind energy installation.

This means that any knowledge gained in connection with other wind energy installations can (also) be used in an advantageous manner. As a result of this, in one embodiment, the wind energy installation can already be controlled immediately in accordance with the invention and/or the (further) machine learning can be improved with the aid of this wind energy installation.

In addition or as an alternative, in one embodiment, the relationship is learned by machine learning with the aid of at least one simulation model, in particular at least one mathematical simulation model, in particular of the one wind energy installation and/or its environment.

As a result of this, in one embodiment, the wind energy installation can already be controlled immediately in accordance with the invention, and/or the (further) machine learning can be (further) improved with the aid of this wind energy installation.

In one embodiment, the relationship continues to be learned by machine learning even while the wind energy installation is being controlled. Accordingly, in one embodiment, the control of the actuator or actuators and/or of the generator is self-learning (by machine learning). As a result of this, in one embodiment, the relationship can be improved, in particular adapted to changing conditions.

In one embodiment, the relationship is implemented with the aid of an artificial neural network, in a further development with the aid of a recurrent artificial neural network or with the aid of an artificial neural network with feedback and/or with the aid of a LSTM network (“long short-term memory”), which are particularly suitable for this purpose. In this way, in one embodiment, the relationship can be learned by machine learning and/or evaluated by machine in a particularly advantageous manner.

In one embodiment, the relationship is learned by machine learning on the basis of a comparison of detected and predicted values of the near field parameter and/or of the operating parameter. In this context, in one embodiment, values of the near field parameter and/or of the operating parameter are predicted for at least a second point in time, the corresponding near field parameter or operating parameter is detected, in particular measured, at this second point in time, and these values are compared with one another, wherein the relationship is learned by machine learning in such a way, and in particular the artificial neural network is consequently trained in such a way, that a quality criterion which is dependent on this difference between these detected and predicted values is optimized. In one embodiment, the time interval between the first point in time and the second point in time can be estimated on the basis of a wind speed, in particular an average wind speed, at the first point in time, which wind speed can be determined from the detected value of the forefield wind parameter. Similarly, the time interval can also be learned by machine learning during this process.

In one embodiment, the relationship can (further) be improved by means of this.

As already mentioned, the relationship can assign values of the near field parameter or of the operating parameter or of the control variable Y to each individual value of the forefield parameter X, in particular according to

$$X ( {t}_{1} ) {\to }^{relationship} Y ( {t}_{2} ) ,$$

wherein t₁ is the first point in time and t₂ is the second point in time.

Likewise, as has also already been mentioned, it can also assign values Y of the near field parameter or of the operating parameter or of the control variable to each value sequence X(t₁−n·Δt), X(t₁−(n−1)·Δt), . . . X(t₁) of several temporally successive values of the forefield parameter, in particular temporally immediately successive values of the forefield parameter, in particular according to

$$\{ X ( {t}_{1} - n \cdot Δ t ) , X ( {t}_{1} - ( n - 1 ) \cdot Δ t ) , … X ( {t}_{1} ) \} {\to }^{relationship} Y ( {t}_{2} ) ,$$

wherein Δt represents the time intervals between individual forefield parameter values. In other words, the relationship can also map a time window (up to the first point in time) to near field parameters or operating parameters or control variables. In this way, in one embodiment, the dynamics, in particular aerodynamics, between the first point in time and the second point in time can be taken into account in a particularly advantageous manner.

In one embodiment, the first distance is at least 10 percent, in particular at least 50 percent, in one embodiment at least 90 percent, and/or at most 1000 percent, in particular at most 800 percent, in one embodiment at most 600 percent, of a length of the rotor blade, i. e., in the case of a multi-bladed rotor with a (maximum) diameter D, in particular at least 0.05 times D, in particular at least 0.25 times D, in one embodiment at least 0.45 times D, and/or at most 5 times D, in particular at most 4 times D, in one embodiment at most 3 times D. It is, as already mentioned, in one embodiment a mean or a minimum distance and/or a distance in the direction of the rotor axis and/or between an upstream edge or front edge or leading edge of a rotor blade and the first region, in particular its rotor-side boundary.

It has been found that, surprisingly, on the basis of forefield parameters detected at this distance from the wind energy installation, in particular from, or in front of, the rotor blade or rotor blades, a wind energy installation or its actuator or actuators and/or its generator can be controlled in a particularly advantageous way.

In one embodiment, the actuator or one or more of the actuators and/or the generator are controlled continuously or quasi-continuously on the basis of the (respective or current) detected forefield parameter value, in particular the (respective or current) detected forefield parameter value sequence, and the relationship learned by machine learning. This has proven to be particularly advantageous in particular for the pitch angle adjustment and control of the generator moment (generator torque), without being limited to this.

In one embodiment, the actuator or one or more of the actuators and/or the generator are controlled on the basis of the (respective or current) detected forefield parameter value, in particular the (respective or current) detected forefield parameter value sequence, and the relationship learned by machine learning, only once a predefined threshold value has been exceeded. This has proven to be particularly advantageous in particular for the azimuth adjustment, without being limited to this.

According to an embodiment of the present invention, a system for controlling the wind energy installation, in particular in terms of hardware and/or software, in particular in terms of programming, is set up for carrying out a method described herein, and/or comprises:
one or more sensors which detect a value of a forefield parameter, in particular of a forefield wind parameter, which is present at a first point in time in a first region which is at a first distance from the wind energy installation, in particular from the rotor blade, in particular a sequence of values of the forefield parameter up to the first point in time, or which one or more sensors are provided for this purpose, in particular set up for this purpose and/or used for this purpose; and
means for controlling one or more actuators of the wind energy installation and/or the generator, on the basis of this detected forefield parameter value, in particular this detected forefield parameter value sequence, and a relationship, learned by machine learning, of a predicted near field parameter, in particular of a near field wind parameter, at the wind energy installation and/or of an operating parameter of the wind energy installation predicted for a later, second point in time and/or of a control variable of the actuator and/or of the generator, to the forefield parameter or the forefield parameter sequences.

In one embodiment, the system, or its means, comprises:
means for predicting the near field parameter and/or the operating parameter on the basis of the detected forefield parameter value or the detected sequence of forefield parameter values and the relationship learned by machine learning;
means for determining a control variable of the actuator and/or of the generator on the basis of this predicted near field parameter and/or the operating parameter, in particular with the aid of a controller; as well as
means for controlling the actuator and/or the generator on the basis of this control variable which has been determined.

In addition or as an alternative, in one embodiment, the system, or its means, comprises:
means for machine learning the relationship with the aid of the wind energy installation and/or at least one further wind energy installation;
means for machine learning the relationship even while the wind energy installation is being controlled; and/or
an artificial neural network with the aid of which the relationship is implemented, or which is provided for this purpose, or which is in particular set up or used for this purpose.

In addition or as an alternative, in one embodiment, the system, or its means, comprises:
means for machine learning the relationship on the basis of a comparison of detected and predicted values of the near field parameter and/or the operating parameter; and/or
means for controlling the actuator or one or more of the actuators and/or the generator continuously or quasi-continuously or only when a predetermined threshold value has been exceeded, on the basis of the detected forefield parameter value, in particular the detected forefield parameter value sequence, and the relationship learned by machine learning.

A means in the sense of the present invention can be constructed in terms of hardware and/or software, and may comprise in particular a processing unit, in particular a microprocessor unit (CPU) or a graphics card (GPU), in particular a digital processing unit, in particular a digital microprocessor unit (CPU), a digital graphics card (GPU) or the like, preferably connected to a memory system and/or a bus system in terms of data or signal communication, and/or may comprise one or more programs or program modules. The processing unit may be constructed so as to process instructions which are implemented as a program stored in a memory system, to acquire input signals from a data bus, and/or to output output signals to a data bus. A memory system may comprise one or more storage media, in particular different storage media, in particular optical media, magnetic media, solid state media and/or other non-volatile media. The program may be of such nature that it embodies the methods described herein, or is capable of executing them, such that the processing unit can execute the steps of such methods and thereby in particular control the wind energy installation. In one embodiment, a computer program product may comprise a storage medium, in particular a non-volatile storage medium, for storing a program or having a program stored thereon, and may in particular be such a storage medium, wherein execution of said program causes a system or a control system, in particular a computer, to carry out a method described herein, or one or more of its steps.

In one embodiment, one or more steps of the method, in particular all steps of the method, are carried out in a fully or partially automated manner, in particular by the system or its means.

In one embodiment, the system comprises the wind energy installation.

Further advantages and features will become apparent from the dependent claims and the example embodiments.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a system for controlling a wind energy installation in accordance with an embodiment of the present invention; and

FIG. 2 shows a method of controlling the wind energy installation in accordance with an embodiment of the present invention.

### DETAILED DESCRIPTION

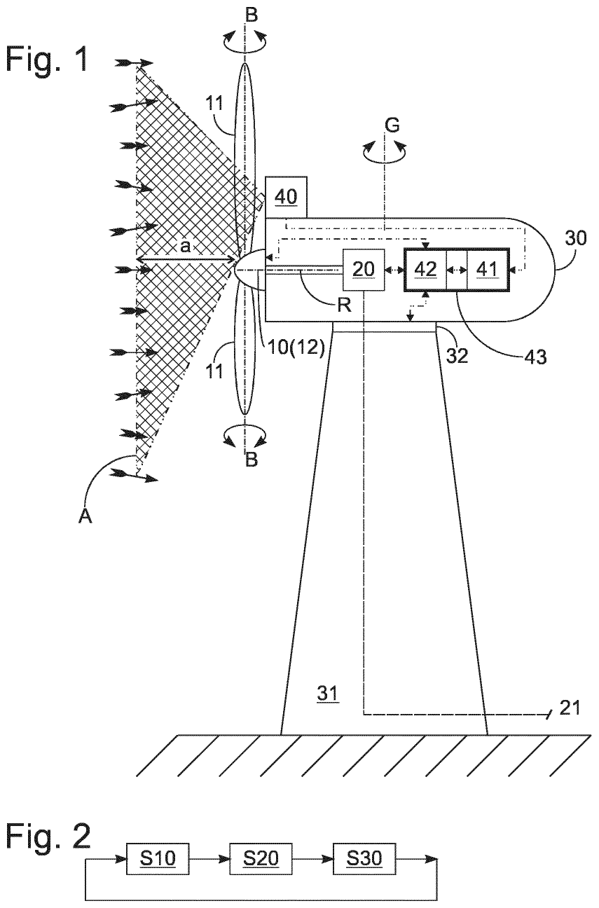

FIG. 1 shows a system for controlling a wind energy installation in accordance with an embodiment of the present invention.

The wind energy installation comprises a rotor 10 with several rotor blades 11 (in the example embodiment three rotor blades 11), which rotor 10 is supported in a nacelle 30 so as to be rotatable about a substantially horizontal rotor axis R, which nacelle 30 is mounted on a tower 31 of the wind energy installation so as to be rotatable about a substantially vertical yaw axis G.

A generator 20 which is coupled to the rotor 10 is arranged in the nacelle 30, which generator 20 feeds electrical energy into an electricity network 21. In one embodiment, the generator 20 comprises a transmission for this purpose, or is coupled to the rotor 10 via a transmission.

Actuators 12 adjust the pitch angles of the rotor blades 11 about their longitudinal axes B or blade axes B. An actuator 32 adjusts the yaw angle or the azimuth of the nacelle 30 with respect to the tower 31.

A lidar, sodar, radar or similar sensor 40 is arranged on the nacelle 30 to detect a multidimensional forefield parameter in the form of wind speeds in a first region A (FIG. 2: step S10) which is arranged at a first distance a in front of the rotor 10.

A control system 43 comprises an artificial neural network 41 and a controller 42.

The neural network 41 receives raw data from the sensor 40 and, in a step S20 (cf. FIG. 2), maps these, on the basis of a machine-learned relationship, to wind speeds at the rotor and/or operating parameter values, for example an aerodynamically induced rotational speed of the rotor, an aerodynamically induced generator moment or the like, which are predicted for a second point in time which is later than a first point in time at which the raw data were acquired. The time delay between the acquired values and the predicted values can be estimated on the basis of a (mean) wind speed which is averaged from the acquired wind speeds, or may also be learned by the neural network 41 by machine learning.

For this purpose, at least in a training phase and preferably also during the normal operation of the wind energy installation, wind speeds at the rotor and/or operating parameter values predicted by the neural network 41 are compared with wind speeds detected at the rotor or operating parameter values detected in the wind energy installation, whereby the neural network 41 seeks to minimize a difference between predicted and detected data by machine learning.

In a step S30, the neural network 41 outputs the predicted wind speeds at the rotor or operating parameter values to a controller 42, which, on the basis of these variables, determines control variables for the generator 20, the pitch angle actuators 12 and the azimuth actuator 32, and outputs the control variables to these. In addition, as already mentioned, during operation or, respectively, in step S20 or S30, the neural network 41 can further improve the relationship of wind speeds in the first region A detected by the sensor 40 at a first point in time and wind speeds at the rotor, or operating parameter values, predicted therefrom for a later, second point in time by (further) machine learning.

Although example embodiments have been explained in the preceding description, it should be noted that a variety of variations are possible.

Thus, in particular, instead of the two-stage method (FIG. 2: S20, S30) with a prediction of wind speeds at the rotor and/or operating parameter values, and a controller 42 which, on the basis of these predicted variables, is predictive (or a controller 42 which operates in a predictive manner on the basis of these predicted variables), the neural network 41 can also, on the basis of the wind speeds in the first region A detected by the sensor 40 at a first point in time and a machine-learned relationship of these forefield parameter values to control variables for the generator 20 and the pitch angle actuators 12, determine each of these control variables directly and use these to control the generator 20, the pitch angle actuators 12 and the azimuth actuator 32.

It should also be noted that the example embodiments are merely examples which are not intended to limit the scope of protection, the applications and the structure in any way. Rather, the preceding description provides the skilled person with a guideline for the implementation of at least one example embodiment, whereby various modifications, in particular with regard to the function and the arrangement of the components described, can be made without departing from the scope of protection as it results from the claims and these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

10 rotor
11 rotor blade
12 pitch angle actuator
20 generator
21 electricity network
30 nacelle
31 tower
32 azimuth actuator
40 sensor
41 artificial neural network
42 controller
43 control system
A first region
a first distance
B blade axis
G Yaw axis
R rotor axis

What is claimed is:

1-12. (canceled)

13. A method of controlling a wind energy installation including a rotor that is rotatable about a rotor axis and which has at least one rotor blade, and a generator coupled to the rotor, the method comprising:
detecting with at least one sensor a value of a forefield parameter that is present at a first point in time and in a first region located a first distance from the wind energy installation; and
controlling with a computer at least one of the generator or at least one actuator of the wind energy installation on the basis of the detected forefield parameter value and a machine-learned relationship of at least one of:
a predicted near field parameter at the wind energy installation,
an operating parameter of the wind energy installation predicted for a later, second point in time,
a control variable of the actuator, or
a control variable of the generator,
to the forefield parameter, or to a sequence of forefield parameter values.

14. The method of claim 13, wherein at least one of:
the forefield parameter is a forefield wind parameter;
the first region is located a distance from the at least one rotor blade;
detecting a value of a forefield parameter comprises detecting a sequence of values of the forefield parameter up to the first point in time; or
controlling at least one of the generator or at least one actuator is based on a detected sequence of values of the forefield parameter up to the first point in time and the machine-learned relationship.

15. The method of claim 13, wherein the at least one sensor is at least one of:
configured to measure values in at least one of a linear or contactless manner; or
arranged on the wind energy installation.

16. The method of claim 15, wherein at least one of:
the sensor is configured to measure values at least one of optically, acoustically, or electromagnetically;
the sensor is arranged on the rotor, a nacelle supporting the rotor, a rotatable nacelle supporting the rotor, or a tower supporting the nacelle.

17. The method of claim 13, wherein at least one of:
the forefield wind parameter depends on at least one of a wind speed, a wind direction, or a wind force, at at least one location of the first region; or
the near field wind parameter depends on at least one of a wind direction or a wind force at at least one location on the wind energy installation.

18. The method of claim 13, wherein the operating parameter depends on at least one of:
a speed of at least one of the rotor, a nacelle supporting the rotor, or the generator;
an acceleration of at least one of the rotor or the nacelle;
a load of at least one of the rotor or the nacelle; or
a power of the generator.

19. The method of claim 18, wherein the nacelle is a rotatable nacelle.

20. The method of claim 13, wherein the at least one actuator adjusts at least one of:
the rotor blade about a longitudinal axis of the rotor blade;
the rotor about a yaw axis; or
a nacelle about a yaw axis, the nacelle supporting the rotor.

21. The method of claim 13, further comprising:
predicting at least one of the near field parameter or the operating parameter on the basis of the detected forefield parameter value or a detected sequence of forefield parameter values and the relationship learned by machine learning;
determining a control variable of at least one of the actuator or of the generator on the basis of at least one of the predicted near field parameter or the operating parameter; and
controlling at least one of the actuator or the generator on the basis of the determined control variable.

22. The method of claim 13, wherein at least one of:
the relationship is learned by machine learning with the aid of at least one of:
the wind energy installation,
at least one further wind energy installation, or
a simulation model;
the relationship continues to be learned by machine learning even while the wind energy installation is being controlled; or
the relationship is implemented with the aid of an artificial neural network.

23. The method of claim 13, wherein the relationship is learned by machine learning on the basis of a comparison of detected and predicted values of at least one of the near field parameter or the operating parameter.

24. The method of claim 13, wherein the first distance is between at least 10 percent and at most 1000 percent of a length of the rotor blade, inclusive.

25. The method of claim 13, wherein at least one of the actuator or the generator is controlled continuously or quasi-continuously or only when a predetermined threshold value has been exceeded.

26. The method of claim 25, wherein:
detecting a value of a forefield parameter comprises detecting a sequence of values of the forefield parameter up to the first point in time; and
controlling on the basis of the detected forefield parameter value comprises controlling on the basis of the detected sequence of forefield parameter values.

27. A system for controlling a wind energy installation that includes a rotor that is rotatable about a rotor axis and which has at least one rotor blade, and a generator coupled to the rotor, the system comprising:
at least one sensor configured for detecting a value of a forefield parameter that is present at a first point in time and in a first region located a first distance from the wind energy installation; and
means for controlling at least one of the generator or at least one actuator of the wind energy installation on the basis of the detected forefield parameter value and a machine-learned relationship of at least one of:
a predicted near field parameter at the wind energy installation,
an operating parameter of the wind energy installation predicted for a later, second point in time,
a control variable of the actuator, or
a control variable of the generator,
to the forefield parameter, or to a sequence of forefield parameter values.

28. The system of claim 27, wherein at least one of:
the forefield parameter is a forefield wind parameter;
the first region is located a distance from the at least one rotor blade;
detecting a value of a forefield parameter comprises detecting a sequence of values of the forefield parameter up to the first point in time; or
controlling at least one of the generator or at least one actuator is based on a detected sequence of values of the forefield parameter up to the first point in time and the machine-learned relationship.

29. A computer program product comprising a program code for controlling a wind energy installation that includes a rotor that is rotatable about a rotor axis and which has at least one rotor blade, and a generator coupled to the rotor, the program code stored on a non-transitory, machine-readable storage medium, the program code configured to, when executed by a computer, cause the computer to:
detect with at least one sensor a value of a forefield parameter that is present at a first point in time and in a first region located a first distance from the wind energy installation; and
control at least one of the generator or at least one actuator of the wind energy installation on the basis of the detected forefield parameter value and a machine-learned relationship of at least one of:
a predicted near field parameter at the wind energy installation,
an operating parameter of the wind energy installation predicted for a later, second point in time,
a control variable of the actuator, or
a control variable of the generator,
to the forefield parameter, or to a sequence of forefield parameter values.

30. The computer program product of claim 29, wherein at least one of:
the forefield parameter is a forefield wind parameter;
the first region is located a distance from the at least one rotor blade;
detecting a value of a forefield parameter comprises detecting a sequence of values of the forefield parameter up to the first point in time; or
controlling at least one of the generator or at least one actuator is based on a detected sequence of values of the forefield parameter up to the first point in time and the machine-learned relationship.
